(19) United States
(12) Patent Application Publication
(10) Pub. No.: US 2025/0232178 A1
(43) Pub. Date: Jul. 17, 2025

(54) USING A RECURRENT NEURAL NETWORK AND A CLASSIFICATION MACHINE LEARNING MODEL TO PREDICT ACTIONS IN SOFTWARE APPLICATIONS

(71) Applicant: INTUIT INC., Mountain View, CA (US)

(72) Inventor: Victor JAYASEELAN, Santa Clara, CA (US)

(21) Appl. No.: 18/413,589

(22) Filed: Jan. 16, 2024

(51) Int. Cl. G06N 3/09

(52) U.S. Cl. CPC G06N 3/09

(57) ABSTRACT

Aspects of the present disclosure provide techniques for machine learning based action prediction. Embodiments include providing, as inputs to a recurrent neural network (RNN), an ordered sequence of strings representing actions performed by a user within a software application, the RNN having been trained through a supervised learning process to generate embeddings of the ordered sequence of strings and generate a numerical score relating to a target action based on the embeddings and an order of the ordered sequence of strings. Embodiments include providing, as respective inputs to a tree-based classification machine learning model, the numerical score and an additional feature relating to the user and receiving, as a respective output from the tree-based classification machine learning model in response to the respective inputs, a propensity score indicating a likelihood of the user to perform the target action.

### INTRODUCTION

Aspects of the present disclosure relate to techniques for automatically predicting user activities in a software application. In particular, embodiments involve using a combination of a recurrent neural network and a classification machine learning model to predict a likelihood of a user performing a target action.

### BACKGROUND

Every year millions of people, businesses, and organizations around the world utilize software applications to assist with countless aspects of life. Many software applications allow users to perform various actions, such as accessing and sharing content, performing financial management, buying and selling products and services, upgrading or otherwise changing to different software application versions, requesting assisted and/or automated support, and/or the like.

In many cases, it is advantageous to predict actions that a user may perform within a software application. For example, a software application may target content to users, initiate processes, and/or otherwise perform certain actions automatically based on a predicted user action, such as a prediction of whether a user is likely to request assisted support, upgrade to a different version of the application, purchase another application or service, discontinue use of the application, and/or the like.

Existing techniques for predicting user activities within software applications involve analyzing different user features, such as including past actions performed by a user, as independent data points about the user for use in determining a likelihood that the user will perform a future action. For example, a tree-based classification machine learning model may accept each user feature as an independent input, and the tree-based classification model may be trained to output a prediction of whether the user will perform a future action based on the independent inputs. However, while these techniques may provide useful results in certain cases, they are of limited value in cases where user features are inter-related. For example, such existing automated user activity prediction techniques do not account for temporal relationships among user features such as an order in which past user actions were performed, due to the way that existing tree-based classification machine learning models process inputs (e.g., processing inputs independently of one another). Accordingly, existing techniques produce inaccurate or limited predictions when user features are inter-related,

What is needed are improved techniques for automatically predicting user actions within software applications based on inter-related user features.

### BRIEF SUMMARY

Certain embodiments provide a method for machine learning based action prediction. The method generally includes: providing, as inputs to a recurrent neural network (RNN), an ordered sequence of strings representing actions performed by a user within a software application, the RNN having been trained through a supervised learning process to: generate embeddings of the ordered sequence of strings; and generate a numerical score relating to a target action based on the embeddings and an order of the ordered sequence of strings; receiving, as an output from the RNN in response to the inputs, the numerical score relating to the target action; providing, as respective inputs to a tree-based classification machine learning model, the numerical score and an additional feature relating to the user; receiving, as a respective output from the tree-based classification machine learning model in response to the respective inputs, a propensity score indicating a likelihood of the user to perform the target action; and performing an action within the software application based on the propensity score.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts example components related to machine learning based action prediction according to embodiments of the present disclosure.

FIG. 2 depicts an example of machine learning based action prediction according to embodiments of the present disclosure.

FIG. 3 depicts an example of aspects related to machine learning based action prediction according to embodiments of the present disclosure.

FIG. 4 depicts an example user interface screen related to machine learning based action prediction according to embodiments of the present disclosure.

FIG. 5 depicts example operations related to machine learning based action prediction according to embodiments of the present disclosure.

FIGS. 6A and 6B depict example processing systems related to machine learning based action prediction according to embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for machine learning based action prediction.

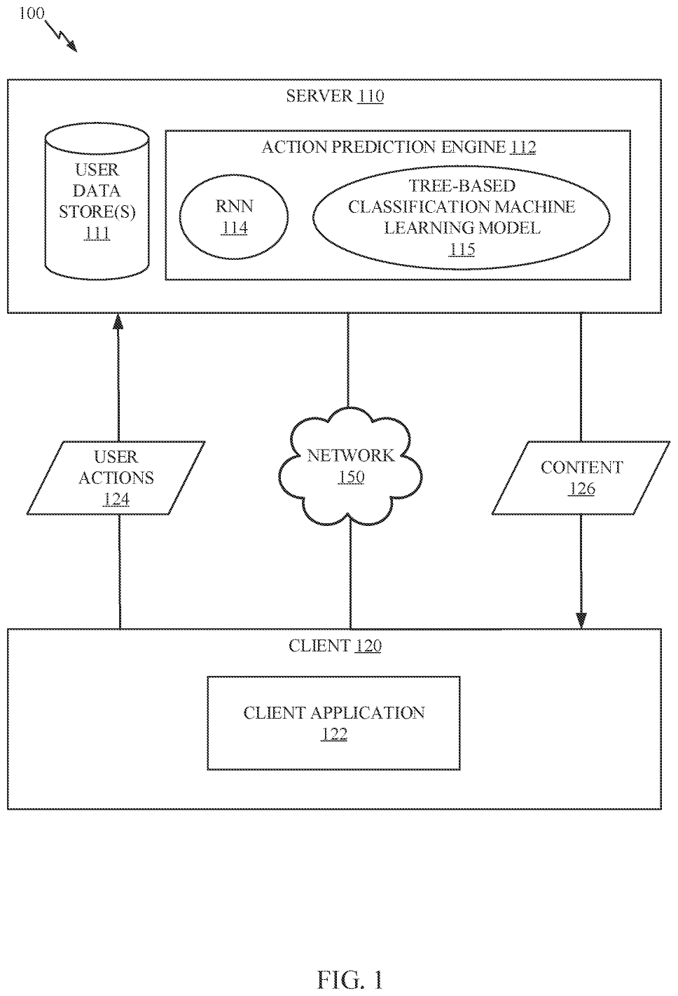

Embodiments described herein involve using a combination of a recurrent neural network (RNN) and a tree-based classification machine learning model to automatically predict a likelihood that a user will perform a target action based on inter-related user features. RNNs and tree-based classification machine learning models are described in more detail below with respect to FIG. 1. An RNN is a type of neural network that evaluates inter-relationships among inputs, such as temporal relationships, though maintaining internal state data. A tree-based classification machine learning model is a type of model that makes a classification by dividing the inputs into smaller classifications (at nodes), which result in an ultimate classification at a leaf. Tree-based classification machine learning models, which are generally used to predict user actions in conventional techniques, are unable to analyze inter-relationships among inputs, such as the temporal ordering of a sequence of inputs. While some existing techniques for predicting user actions involve the use of a tree-based classification machine learning model, embodiments described herein involve a unique combination of an RNN and a tree-based classification machine learning model that provides particular technical benefits for generating automated predictions based on user features that are inter-related.

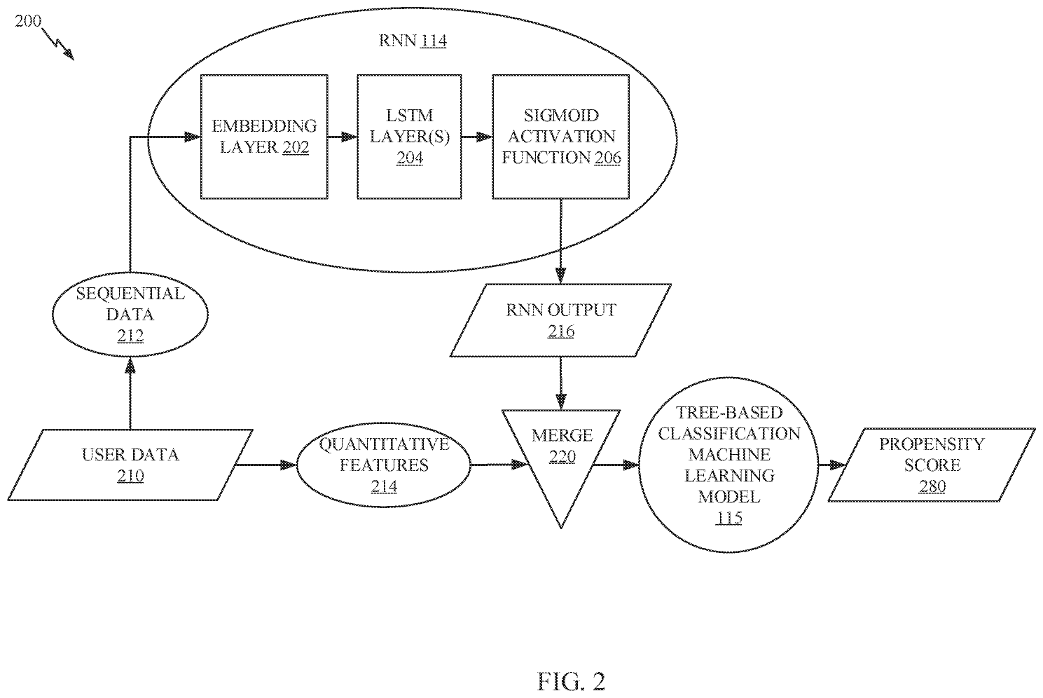

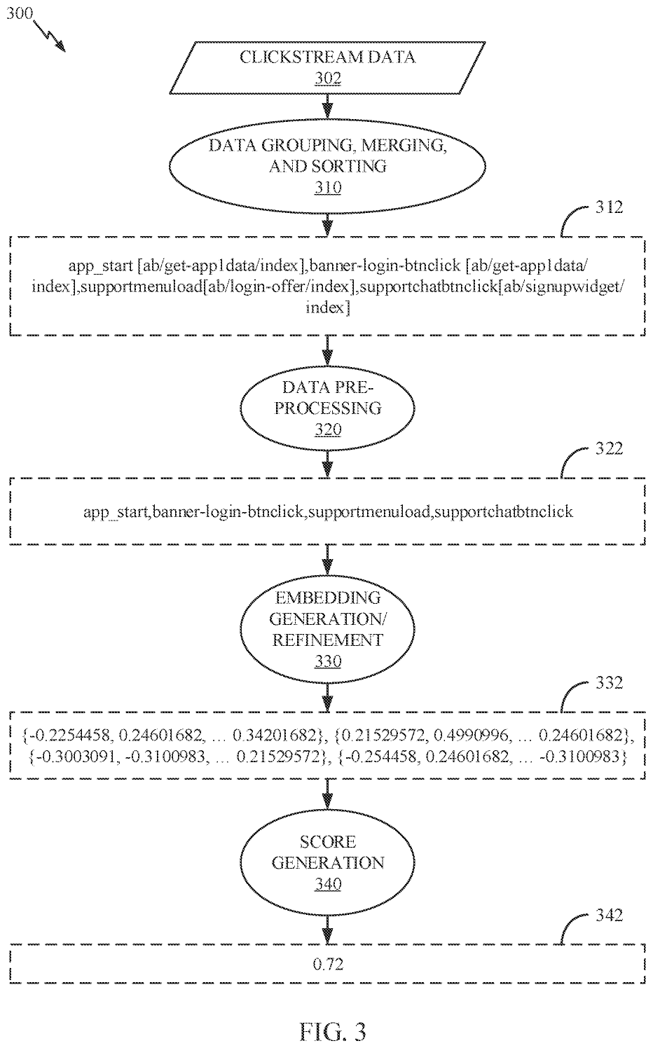

As described in more detail below with respect to FIGS. 1 and 2, a user may perform actions within a software application, and records of these user actions may be retrieved and used to provide inputs to an RNN. The RNN is trained to output a numerical score indicating a likelihood that the user will perform a target action based on the temporal ordering of the user actions. As described in more detail below with respect to FIG. 3, the user action records may be preprocessed in order to provide suitable inputs to the RNN, and the RNN may generate embeddings (e.g., vector representations) of the user actions for use in determining the numerical score. The numerical score output by the RNN may represent the likelihood of the user performing the target action in view of the user actions themselves in addition to the temporal order in which the user actions were historically performed.

The numerical score generated by the RNN may then provided along with one or more additional user features as inputs to a tree-based classification machine learning model, as described in more detail below with respect to FIG. 2. The tree-based classification machine learning model may, for example, be a gradient boosted tree model or another type of tree model that is trained to output a propensity score indicating a likelihood that the user will perform the target action based on the numerical score from the RNN and one or more other user features. The tree-based classification machine learning model provides a number of benefits but does not analyze inter-relationships among input features such as the temporal ordering of user actions, instead analyzing each input independently. However, because the numerical score output by the RNN represents the likelihood of the user performing the target action in view of the user actions themselves and the temporal order in which the user actions were historically performed, the tree-based classification machine learning model is able to consider the inter-relationships (e.g. temporal ordering) of the user actions as part of its analysis despite analyzing each input independently (e.g., because the numerical score captures such inter-relationships within a single input feature). Thus, the benefits of a tree-based classification machine learning model may be obtained, such as efficient processing, simplicity, and explainability (e.g., unlike RNNs, tree-based classification models are able to output indications of which input features contributed most to a prediction), while still accounting for inter-relationships among input features through the use of an output from the RNN as an input to the tree-based classification model.

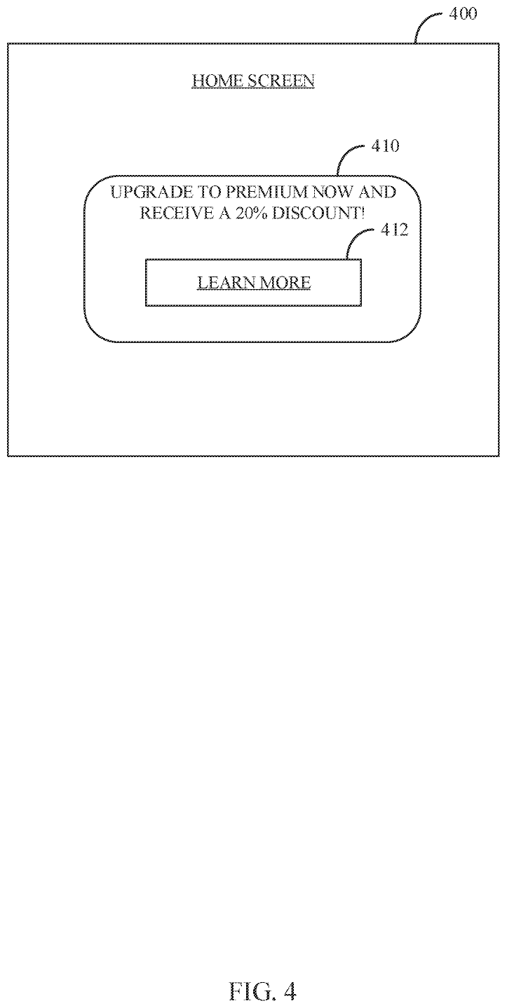

According to certain embodiments, the propensity score output by the tree-based classification model may be used to automatically perform one or more actions within the software application. For example, if the propensity score indicates that the user has a high likelihood (e.g., beyond a threshold) of upgrading to a different application version, then the user may be automatically provided with an offer to upgrade, as described in more detail below with respect to FIG. 4. In another example, if the propensity score indicates that the user has a high likelihood (e.g., beyond a threshold) of discontinuing use of the application, then the user may be automatically provided with an offer of a discount, a live support session may automatically be initiated with the user, and/or the like.

Techniques described herein improve the technical field of automated user activity prediction. For instance, by utilizing an RNN to produce a numerical score based on an ordered sequence of user actions and then using the numerical score as an input, along with one or more other inputs, to a tree-based classification machine learning model for use in generating a propensity score with respect to a target action, techniques described herein allow the ordering of a historical sequence of user actions to be considered within a tree-based model in a manner that could not be achieved previously. Thus, the technical benefits of a tree-based classification machine learning model (e.g., explainability, simplicity, and computational efficiency) may be attained while also producing a result that is based on inter-relationships among user features, such as the temporal ordering of historical user actions. An RNN by itself would provide analysis of inter-relationships among inputs, but would not provide explainability (e.g., because RNNs do not output indications of which input features contributed most to outputs), and would require a larger amount of computing resources than a tree-based model in order to consider other user features such as user profile data together with the temporal relationships among a sequence of user actions. Therefore, the combination of an RNN and a tree-based classification machine learning model described herein allows a user action propensity score to be automatically predicted in a resource-efficient manner based on the temporal relationships among a sequence of user actions as well as based on additional user features, thereby improving the accuracy and efficiency of generating such predictions and improving the functioning of the computing devices involved (e.g., through reduced resource consumption compared to alternative techniques).

Additionally, by improving the accuracy of automated user action predictions, techniques described herein allow automated actions to be performed based on such predictions with a higher degree of accuracy and relevancy. For example, techniques described herein avoid computing resource utilization that would otherwise occur in connection with automatically performing irrelevant or inaccurate actions based on inaccurate predictions of user actions. Furthermore, techniques described herein improve the functioning of computing applications by allowing user issues (e.g., issues that would otherwise lead to technical support or the user discontinuing use of the application) to be preemptively predicted and addressed without requiring users to seek out solutions to such issues and expending time and computing resources in the process. While existing automated user action prediction techniques provide some measure of accuracy, embodiments of the present disclosure involve the use of a unique arrangement of machine learning models in a particular manner to produce predictions that are more accurate and more efficiently generated than those that would be produced by conventional and alternative techniques, thereby technically improving upon such conventional and alternative techniques.

### Example Computing Components for Machine Learning Based Action Prediction

FIG. 1 is an illustration 100 of example computing components related to machine learning based action prediction.

Illustration 100 includes a server 110 comprising an action prediction engine 112, which generally performs operations related to machine learning based action prediction using a recurrent neural network (RNN) 114 and a tree-based classification machine learning model 115. Server 110 also includes one or more user data stores 111, which may include data related to one or more users of a software application such as client application 122. Data stored in user data store(s) 111 may include historical user action data (e.g., electronic records of user actions performed within the software application, such as in the form of an order sequence of actions) and other user features such as user profile data (e.g., including such user attributes as geographic location, occupation, length of use of the application, application features enabled, application version currently being used, and/or the like).

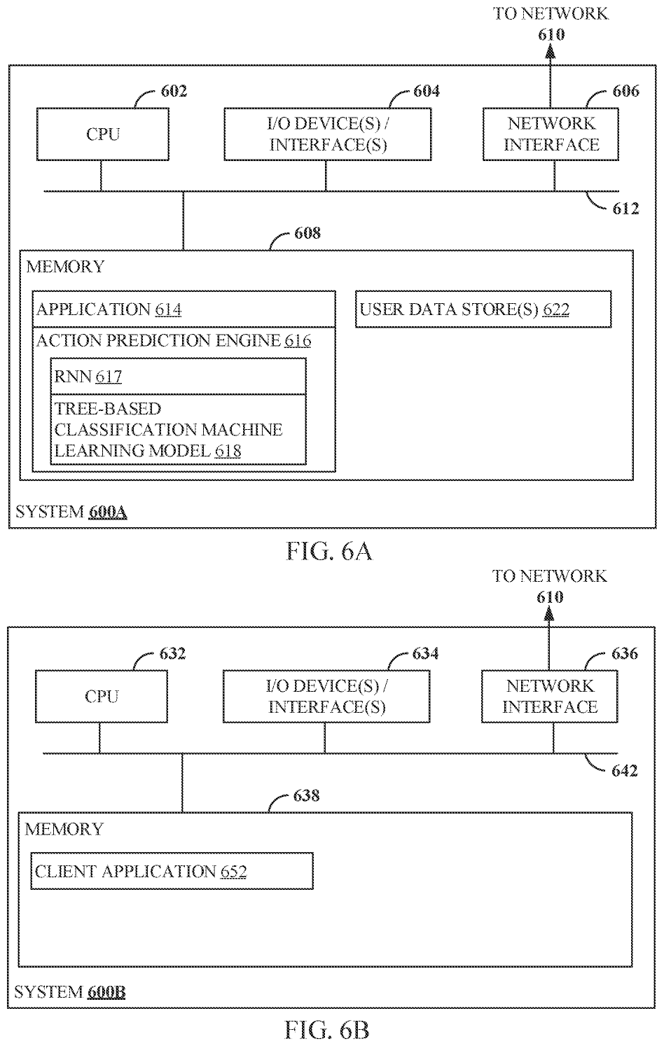

Server 110 may be a computing device such as system 600A of FIG. 6A, which is described in more detail below. Action prediction engine 112 generally represents a software component that utilizes RNN 114 and tree-based classification machine learning model 115 in order to automatically determine a likelihood of a user performing a target action. It is noted that while RNN 114 and tree-based classification machine learning model 115 are depicted within action prediction engine 112, one or more of these models may alternatively be located outside of action prediction engine 112 and/or outside of server 110, such as on one or more endpoints accessible by action prediction engine 112 (e.g., via network 150). In some embodiments, RNN 114 and tree-based classification machine learning model 115 may be characterized together as an ensemble model.

There are different types of machine learning models that can be used in embodiments of the present disclosure, such as for RNN 114 and tree-based classification machine learning model 115. For example, RNN may comprise one or more different types of neural networks while tree-based classification machine learning model 115 may comprise one or more different types of tree-based classification models.

Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. In some cases, a neural network comprises one or more aggregation layers, such as a softmax layer. A recurrent neural network (RNN) is a type of neural network designed to process sequential data, such as an ordered sequence of strings (e.g., representing user actions) or other inputs. RNNs have feedback connections that allow for retaining information from previous steps, enabling RNNs to capture temporal dependencies. An example of an RNN is a long short term memory (LSTM) network, which may be implemented via one or more LSTM layers in a deep neural network. An RNN as described herein may utilize natural language processing techniques to generate, refine, and/or analyze embeddings of strings.

In a neural network, each node or neuron in an LSTM layer generally includes a cell, an input gate, an output gate and a forget gate. The cell generally stores or “remembers” values over certain time intervals in both a backward direction (e.g., data input to the node) and a forward direction (e.g., data output by the node), and the gates regulate the flow of data into and out of the cell. As such, an LSTM layer hones a representation (e.g., embedding) by modifying vectors based on remembered data, thereby providing a more contextualized representation of an input sequence. A bi-directional LSTM operates in both a forward and backward direction. In one example, RNN 114 comprises one or more LSTM layers and a sigmoid activation function that takes any real value(s) (e.g., embeddings output by the one or more LSTM layers) as input and outputs a value in the range of 0 to 1. The larger the input, the closer the output value of the sigmoid activation function will be to 1.0, and the smaller the input, the closer the output of the sigmoid activation function will be to 0.0. RNN 114 may be trained to output a value in the range of 0 to 1 indicating a probability that a user will perform a target action in response to inputs representing an ordered series of user actions.

In some embodiments, training of a machine learning model such as RNN 114 is a supervised learning process that involves providing training inputs (e.g., an ordered series of text strings representing user actions of a user) as inputs to a machine learning model. The machine learning model processes the training inputs and outputs predictions (e.g., numerical scores between 0 and 1 indicating a likelihood that the user will perform a target action) based on the training inputs. The predictions are compared to the known labels associated with the training inputs (e.g., ground truth labels indicating whether the user actually performed the target action after performing the actions represented by the training inputs) to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. Training data may be generated by grouping user features and labels (e.g., which are based on user activity data indicating whether users performed target actions) based on unique user identifiers associated with such user data in user data store(s) 111. The training data for RNN 114 may be a subset of user data for one or more users, such as ordered sequences of text strings representing user actions of the one or more users and labels indicating whether the one or more users actually performed the target action after performing the actions represented by the ordered sequences of text strings.

RNN 114 may generate and/or refine embeddings of an ordered sequence of inputs (e.g., strings representing user actions) and generate a numerical score based on such embeddings. An embedding generally refers to a vector representation of an entity that represents the entity as a vector in n-dimensional space such that similar entities are represented by vectors that are close to one another in the n-dimensional space.

Tree-based classification machine learning model 115 generally accepts a numerical score output by RNN 114 as an input, as well as other inputs, and outputs a numerical score referred to as a propensity score that represents a likelihood that a user will perform a target action (e.g., the same target action to which the numerical score output by RNN 114 relates). A tree-based model (e.g., a decision tree) makes a classification by dividing the inputs into smaller classifications (at nodes), which result in an ultimate classification at a leaf. Boosting, or gradient boosting, is a method for optimizing tree models. Boosting involves building a model of trees in a stage-wise fashion, optimizing an arbitrary differentiable loss function. In particular, boosting combines weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. In one example, tree-based classification machine learning model 115 is a gradient boosted tree model. Examples of gradient boosted tree models include XGBoost and LightGBM. In another example, tree-based classification machine learning model 115 is a random forest model. A random forest extends the concept of a decision tree model, except the nodes included in any given decision tree within the forest are selected with some randomness. Thus, random forests may reduce bias and group outcomes based upon the most likely positive responses.

It is noted that these are included as example model types, and tree-based classification machine learning model 115 may be any suitable type of tree-based classification machine learning model.

Tree-based classification machine learning model 115 may be trained through a supervised learning process in a similar manner as that described above with respect to RNN 114. For example, training of a tree-based classification machine learning model 115 may involve providing training inputs (e.g., a numerical score output by RNN 114 and one or more additional user features, which may also be represented numerically) as inputs to tree-based classification machine learning model 115. Tree-based classification machine learning model 115 processes the training inputs and outputs predictions (e.g., numerical scores between 0 and 1 indicating a likelihood that the user will perform a target action) based on the training inputs. The predictions are compared to the known labels associated with the training inputs (e.g., ground truth labels indicating whether the user represented by the training inputs actually performed the target action) to determine the accuracy of tree-based classification machine learning model 115, and parameters of tree-based classification machine learning model 115 are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by tree-based classification machine learning model 115 based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions, and the like. In some embodiments, validation and testing are also performed for tree-based classification machine learning model 115, such as based on validation data and test data, as is known in the art. The training data for tree-based classification machine learning model 115 may be numerical scores output by RNN 114 for ordered sequences of actions of one or more users merged with a subset of user data for the one or more users, such as additional quantitative features of the one or more users, and labels indicating whether the one or more users actually performed the target action after performing the actions represented by the ordered sequences of text strings.

Client 120 may be a computing device such as system 600B of FIG. 6B, described in more detail below. Client application 122 generally represents a software application with which a user interacts via client 120. In one example, user actions 124 represent actions performed by a user of client application 122. Examples of user actions 124 include launching an application, interacting with user interface components (e.g., clicking and/or providing input), logging in, accessing, interacting with, and/or providing content, requesting live support or automated support, interacting with and/or connecting with other users, buying and/or selling products (e.g., other applications) or services, upgrading or changing software versions, and/or the like. In some embodiments, user actions 124 are represented as clickstream data that represents an ordered series of “clicks” or actions, or addresses such as uniform resource locators (URLs) of pages visited, such as via client application 122 (which may, in some embodiments, comprise a web browser). User actions 124 may also be referred to as user journey data. User actions 124 are provided to server 110 and stored within user data store(s) 111. User data store(s) 111 may also store other user types of user data, such as user attributes from user profiles.

Action prediction engine 112 may retrieve user actions 124 from user data store(s) 111, such as via one or more calls to one or more application programming interface(s) associated with user data store(s) or via one or more other retrieval mechanisms. As described in more detail below with respect to FIG. 3, action prediction engine 112 may perform preprocessing on the retrieved user action data, such as extracting an ordered sequence of strings (e.g., tokens) representing user actions and excluding additional data such as metadata, addresses or locators, and/or the like. Action prediction engine 112 may then provide the preprocessed user actions, such as an ordered sequence of strings representing user actions, as inputs to RNN 114. RNN 114 may generate and/or refine embeddings of the inputs, as described in more detail below with respect to FIG. 3, and may generate a numerical score based on such embeddings. The numerical score output by RNN 114 may then be provided by action prediction engine 112 as an input to tree-based classification machine learning model 115. Action prediction engine 112 may also retrieve one or more additional user features from user data store(s) 111, such as a geographic location of the user, a length of time that the user has used the application, an occupation of the user, an application version of the user, one or more other applications or services used by the user, and/or the like, and may provide one or more additional inputs to tree-based classification machine learning model 115 based on such additional user features (e.g., in numerical form, such as in the form of an encoded vector such as one-hot encoding, a binary indicator, an embedding, a direct numerical value, a score, and/or the like).

Tree-based classification machine learning model 115 may output a propensity score in response to the inputs. The propensity score indicates a likelihood that the user will perform the target action. The target action may be, for example, requesting live support or automated support, upgrading or changing application versions, purchasing a product or service such as purchasing another application, discontinuing use of the application, accessing a certain type of content, and/or the like. Action prediction engine 112 or another component may use the propensity score output by tree-based machine learning model 115 to automatically perform one or more actions. For example, is the propensity score is above a threshold, which indicates that the user is likely to perform the target action, then content 126 related to the target action may automatically be provided to the user. For example, server 110 may send content 126 to client 120 for display via client application 122, as described in more detail below with respect to FIG. 4. Providing content is one example of an action that may be taken based on the propensity score, and other types of actions may also or alternatively be automatically performed based on the propensity score. For example, the propensity score may be provided to one or more entities related to a product or service so that the one or more entities can determine whether to provide content to the user based on the propensity score or to perform another type of action. Automatically performed actions may include, for example, providing content, transmitting a message, generating a report or visualization, activating an application feature, initiating a live support or automated support session, and/or the like.

While not shown, one or more of user data source(s) 111 may be located separately from server 110, such as being accessible via network 150. For example, user data source(s) 111 may include websites, databases, data stores, logs, online accounts, application components, and other endpoints from which electronic data may be retrieved, such as via one or more application programming interfaces (APIs) or other retrieval mechanisms.

Network 150 may be any type of connection over which data may be transmitted. In one example, network 150 is the Internet.

In some embodiments, user feedback may be received with respect to a propensity score output by tree-based classification machine learning model 115. For example, the user feedback may be in the form of the user performing the target action after the propensity score is generated or not performing the target action within a threshold amount of time after generating the propensity score or within a threshold amount of time after automatically performing the action (e.g., providing content 126) based on the propensity score. In other examples, the user feedback may be in the form of the user responding positively or negatively or not responding within a threshold amount of time to an action automatically performed based on the propensity score, such as the providing of content 126. For example, if the user accesses or interacts positively (e.g., liking, sharing, saving, providing positive natural language or rating feedback, and/or the like) with content 126, then the user feedback may indicate a positive response to the propensity score while if the user does not access (e.g., within a threshold amount of time) or interacts negatively (e.g., disliking or down voting, closing or otherwise rejecting, providing negative natural language or rating feedback, and/or the like) with content 126, the user feedback may indicate a negative response to the propensity score.

The user feedback may be used to retrain tree-based classification machine learning model 115 and/or RNN 114. For example, updated training data generated for tree-based machine learning model 115 may include the input features used to generate the propensity score associated with a label indicating a 0 or a 1 depending on whether the user feedback indicates that the user did or did not have a propensity to perform the target action. Similarly, updated training data generated for RNN 114 may include the input features (e.g., ordered sequence of user actions) used to generate the numerical score associated with a label indicating a 0 or a 1 depending on whether the user feedback indicates that the user did or did not have a propensity to perform the target action. The updated training data for tree-based classification machine learning model 115 may be used to re-train tree-based classification machine learning model 115 through a supervised learning process as described above. Similarly, the updated training data for RNN 114 may be used to re-train RNN 114 through a supervised learning process as described above. Furthermore, as users perform additional actions within the application, these additional actions may be used to generate new labeled training data instances, such as including user features (e.g., ordered sequences of actions preceding a given action and/or additional user features) associated with a binary label of 1 indicating that the user represented by the features performed the given action and therefore had the propensity to perform the given action. New labeled training data instances may be used to retrain tree-based classification machine learning model 115 and/or RNN 114.

Re-training RNN 114 and/or tree-based classification machine learning model 115 based on user feedback provides an interactive feedback loop by which these machine learning models may be iteratively updated and improved over time. Thus, techniques described herein provide a system that automatically becomes more accurate and reduces false positives over time through such re-training.

Re-training may be performed “online” (e.g., as user feedback becomes available, such as in real time) or “offline” (e.g., in batches, such as at regular intervals or each time a threshold amount of new training data becomes available based on user feedback).

In some embodiments the same RNN 114 and tree-based classification machine learning model 115 are trained for multiple target actions. For example, RNN 114 may output a plurality of numerical scores, each corresponding to a different target action of a plurality of target actions, and tree-based classification machine learning model 115 may output a plurality of propensity scores, each corresponding to a different target action of the plurality of target actions. In another example, inputs provided to RNN 114 and tree-based classification machine learning model 115 may include an indication of a specific target action, and the output of RNN 114 and tree-based classification machine learning model 115 may correspond to that specific target action. In other embodiments, separate versions of RNN 114 and tree-based classification machine learning model 115 may be trained for each of a plurality of target actions.

### Example Machine Learning Based Action Prediction

FIG. 2 is an illustration 200 of an example of an example of machine learning based action prediction according to embodiments of the present disclosure. Illustration 200 includes RNN 114 and tree-based classification machine learning model 115 of FIG. 1. Illustration 200 depicts functionality of action prediction engine 112 of FIG. 1.

User data 210 generally represents user features of a user, such as including user activity data and other user features such as user profile data. Sequential data 212, which generally represents an ordered sequence of user actions (e.g., user journey data comprising actions performed, web pages visited, and/or the like) from user data 210, is provided to RNN 114, and is received by an embedding layer 202 of RNN 114. Embedding layer 202 generates embeddings of the strings in sequential data 212, and the embeddings are further refined through one or more LSTM layers 204. In alternative embodiments embedding layer 202 is part of the one or more LSTM layers 204 (e.g., the embeddings may be generated, and not just refined, by the one or more LSTM layers 204). The embeddings are then processed by a sigmoid activation function 206 that generates an RNN output 216 (e.g., a probability score, such as a numerical score between 0 and 1) based on the embeddings and based on the ordering of the actions (represented by the embeddings) in sequential data 212. A sigmoid activation function is included as an example, and other types of functions that produce a numerical score based on a plurality of ordered inputs may also be used. RNN output 216 generally represents a likelihood that the user represented by user data 210 will perform a target action.

At merging 220, RNN output 216 is combined with one or more additional quantitative features 214 from user data 210. Quantitative features 214 may include, for example, user profile features or other attributes of the user. The merged features (e.g., RNN output 216 and quantitative features 214) are then provided as inputs to tree-based classification machine learning model 115. Tree-based classification machine learning model 115 outputs a propensity score 280 based on the inputs. For example, propensity score 280 may be a numerical score between 0 and 1 that indicates a likelihood that the user represented by user data 210 will perform the target action (e.g., the same target action to which RNN output 216 corresponds). While not shown, tree-based classification machine learning model 115 may also output, in some embodiments, explainability information along with propensity score 280, such as indicating respective contributions of different inputs (e.g., RNN output 216 and quantitative features 214) to propensity score 280. Explainability information may, for example, indicate the importance or significance of particular input features with respect to the output, as is known in the art of tree-based machine learning models. Such explainability information may allow for better explainability and/or auditing of predictions produced by tree-based classification machine learning model 115.

It is noted that while embeddings generated by RNN 114 could be directly provided as input features to tree-based classification machine learning model 115 (e.g., instead of RNN output 216), such an alternative technique would not capture the temporal relationships between the actions represented by the embeddings, as tree-based classification models do not consider such temporal relationships among inputs. Providing RNN output 216 (e.g., the final output of RNN 114) as an input to tree-based classification machine learning model 115 allows tree-based classification machine learning model 115 to consider the temporal relationships between the actions performed by the user, as RNN output 216 (e.g., unlike the embeddings on their own) captures such temporal relationships.

### Example RNN Processing

FIG. 3 is an illustration 300 of aspects related to machine learning based action prediction according to embodiments of the present disclosure. FIG. 3 generally represents additional detail with respect to inputs provided to and processing performed by RNN 114 of FIGS. 1 and 2.

At data grouping, merging, and sorting 310, clickstream data 302 is processed to produce ordered data set 312. Clickstream data 302 generally represents data retrieved from one or user more data sources 111, and includes electronic records of an ordered series of user actions. Data grouping, merging, and sorting 310 may include, for example, grouping and merging user activity data relating to the user from multiple data sources and/or from multiple application login sessions and sorting such user activity data in temporal order. Ordered data set 312 generally includes an ordered series of electronic user activity records, including strings representing user actions (e.g., “app_start” and “banner-login-btnclick”) and other data (e.g., metadata or other types of information such as the path “[ab/get-app1data/index]”).

At data pre-processing 320, ordered data set 312 is pre-processed to produce an ordered sequence of strings 322. Data pre-processing 320 generally represents extracting a series of strings (e.g., which may be referred to as tokens) representing user actions from ordered data set 312, such as excluding other data such as metadata. Data pre-processing 320 may include what is referred to as a tokenization process, whereby tokens or strings representing actions are extracted. Data pre-processing 320 may be based on a database (or other data set) of known strings that represent user actions, and/or based on rules such as regular expressions, space-based tokenization, and/or the like. Ordered sequence of strings 322 generally includes an ordered sequence of strings representing user actions that were extracted from ordered data set 312. For example, ordered sequence of strings 322 includes the strings app_start, banner-login-btnclick, supportmenuload, and supportchatbtnclick.

At embedding generation/refinement 330, embeddings 332 are generated based on ordered sequence of strings 322. As described above, embeddings 332 may be generated and/or refined by operation of one or more embedding layers and/or one or more LSTM layers of RNN 114 of FIGS. 1 and 2. Embeddings 332 include representations of the strings in ordered sequence of strings 322 as n-dimensional vectors such as {−0.2254458, 0.24601682, . . . 0.34201682}.

At score generation 340, a numerical score 342 is generated based on embeddings 332. For example, score generation 340 may involve evaluating a sigmoid activation function based on embeddings 332 and the ordering of embeddings 332 to produce numerical score 342. Numerical score 342, which may correspond to RNN output 216 of FIG. 2, may be a numerical value between 0 and 1 indicating a likelihood that the user will perform a target action. As described above with respect to FIGS. 1 and 2, numerical score 342 may then be provided as an input, along with one or more additional user features, to a tree-based classification model in order to produce a propensity score indicating a likelihood that the user will perform the target action. The propensity score may then be used to perform one or more actions, such as providing content as described below with respect to FIG. 4.

### Improved User Interface Screen Related to Machine Learning Based Action Prediction

FIG. 4 illustrates an example user interface screen 400 related to machine learning based action prediction. For example, user interface screen 400 may correspond to client application 122 of FIG. 1.

User interface screen 400 represents a screen of a graphical user interface associated with a software application. For example, a user may interact with user interface screen 400 to request, receive, and provide information within the application.

A window 410 is displayed within user interface screen 400 (e.g., on a home screen other screen within the application). Window 410 includes a message prompting the user to upgrade to a premium version of the application now and receive a 20% discount. For example, window 410 may correspond to content 126 of FIG. 1. Window 410 includes a user interface component 412 that, when selected, causes additional information related to the message to be displayed, such as a screen for initiating an upgrade process according to the offer presented in the message.

Window 410 may be automatically displayed based on a propensity score output by the tree-based classification machine learning model as described herein. For example, the propensity score may indicate that the user has a likelihood above a threshold of upgrading to the premium version of the application, and so window 410 may be automatically presented based on the propensity score in order to prompt the user to complete the upgrade that the user is predicted to have a high propensity of completing. Upgrading is included as an example, and other types of target actions may also be encouraged through content, prompts, messages, and/or the like. For example, a user may be provided with an offer to purchase a different application if a propensity score indicates that the user has a high likelihood of purchasing the other application. Thus, embodiments of the present disclosure provide improved automated upselling and/or cross-selling opportunities.

It is noted that user interface screen 400 is included as an example, and other methods of providing content to users and receiving input from users may also be used.

### Example Operations for Machine Learning Based Action Prediction

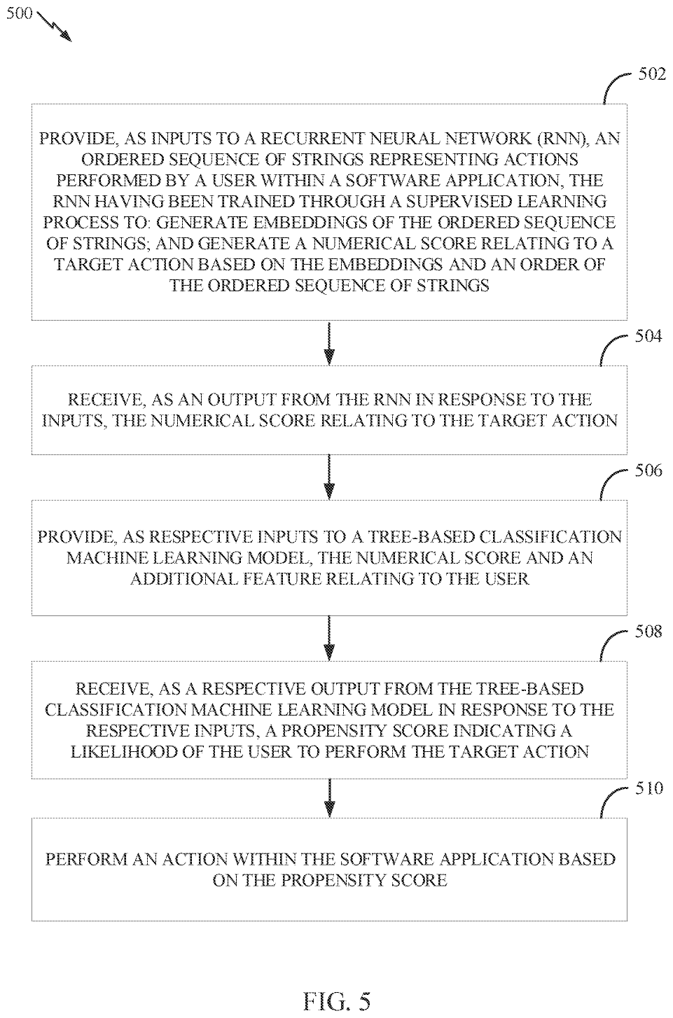

FIG. 5 depicts example operations 500 for machine learning based action prediction. For example, operations 500 may be performed by server 110 of FIG. 1.

Operations 500 begin at step 502, with providing, as inputs to a recurrent neural network (RNN), an ordered sequence of strings representing actions performed by a user within a software application, the RNN having been trained through a supervised learning process to generate embeddings of the ordered sequence of strings and generate a numerical score relating to a target action based on the embeddings and an order of the ordered sequence of strings.

Certain embodiments further comprise retrieving activity history data for the user from one or more electronic data sources and extracting the ordered sequence of strings from the activity history data through a tokenization process. Some embodiments further comprise computing, by the RNN, a sigmoid activation function based on the embeddings and the order of the ordered sequence of strings to generate the numerical score.

In some embodiments, the RNN comprises a long short term memory (LSTM) network trained based on historical ordered sequences of strings associated with labels indicating whether the target action was historically performed.

Operations 500 continue at step 504, with receiving, as an output from the RNN in response to the inputs, the numerical score relating to the target action.

Operations 500 continue at step 506, with providing, as respective inputs to a tree-based classification machine learning model, the numerical score and an additional feature relating to the user. In some embodiments, the tree-based classification machine learning model comprises a gradient boosted tree model trained based on historical user features, including historical numerical scores output by the RNN, associated with the labels indicating whether the target action was historically performed.

Operations 500 continue at step 508, with receiving, as a respective output from the tree-based classification machine learning model in response to the respective inputs, a propensity score indicating a likelihood of the user to perform the target action.

Some embodiments further comprise comprising receiving, from the tree-based classification machine learning model based on the respective inputs, explainability information indicating respective contributions of the numerical score and the additional feature to the propensity score.

Operations 500 continue at step 510, with performing an action within the software application based on the propensity score. In some embodiments, the performing of the action within the software application based on the propensity score comprises displaying content related to the target action within the software application based on the propensity score or generating a message related to the target action within the software application based on the propensity score.

Some embodiments further comprise receiving user feedback with respect to the propensity score, wherein the tree-based classification machine learning model is re-trained based on the user feedback. Certain embodiments further comprise receiving user feedback with respect to the propensity score, wherein the RNN is re-trained based on the user feedback.

Notably, method 500 is just one example with a selection of example steps, but additional methods with more, fewer, and/or different steps are possible based on the disclosure herein.

### Example Computing Systems

FIG. 6A illustrates an example system 600 with which embodiments of the present disclosure may be implemented. For example, system 600A may correspond to server 110 of FIG. 1, and may be configured to perform one or more of operations 500 of FIG. 5.

System 600A includes a central processing unit (CPU) 602, one or more I/O device interfaces 604 that may allow for the connection of various I/O devices 614 (e.g., keyboards, displays, mouse devices, pen input, etc.) to the system 600A, network interface 606, a memory 608, and an interconnect 612. It is contemplated that one or more components of system 600A may be located remotely and accessed via a network 610. It is further contemplated that one or more components of system 600A may comprise physical components or virtualized components.

CPU 602 may retrieve and execute programming instructions stored in the memory 608. Similarly, the CPU 602 may retrieve and store application data residing in the memory 608. The interconnect 612 transmits programming instructions and application data, among the CPU 602, I/O device interface 604, network interface 606, and memory 608. CPU 602 is included to be representative of a single CPU, multiple CPUs, a single CPU having multiple processing cores, and other arrangements.

Additionally, the memory 608 is included to be representative of a random access memory or the like. In some embodiments, memory 608 may comprise a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, memory 608 includes an application 614, which may be a software application that provides various types of functionality, such as allowing a user to perform actions and/or be provided with content as described herein. Memory 608 further includes action prediction engine 616, RNN 617, tree-based classification machine learning model 618, and user data store(s) 622, which may correspond to action prediction engine 112, RNN 114, tree-based classification machine learning model 115, and user data store(s) 111 of FIG. 1.

FIG. 6B illustrates another example system 600B with which embodiments of the present disclosure may be implemented. For example, system 600B may correspond to client 120 of FIG. 1, and may be configured to display user interface screen 400 of FIG. 4.

System 600B includes a CPU 632, one or more I/O device interfaces 634 that may allow for the connection of various I/O devices 634 (e.g., keyboards, displays, mouse devices, pen input, etc.) to the system 600B, network interface 636, a memory 638, and an interconnect 642. It is contemplated that one or more components of system 600B may be located remotely and accessed via a network 610. It is further contemplated that one or more components of system 600B may comprise physical components or virtualized components.

CPU 632 may retrieve and execute programming instructions stored in the memory 638. Similarly, the CPU 632 may retrieve and store application data residing in the memory 638. The interconnect 642 transmits programming instructions and application data, among the CPU 632, I/O device interface 634, network interface 636, and memory 638. CPU 632 is included to be representative of a single CPU, multiple CPUs, a single CPU having multiple processing cores, and other arrangements.

Additionally, the memory 638 is included to be representative of a random access memory or the like. In some embodiments, memory 638 may comprise a disk drive, solid state drive, or a collection of storage devices distributed across multiple storage systems. Although shown as a single unit, the memory 638 may be a combination of fixed and/or removable storage devices, such as fixed disc drives, removable memory cards or optical storage, network attached storage (NAS), or a storage area-network (SAN).

As shown, memory 638 includes a client application 652, which may correspond to client application 122 of FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for machine learning based action prediction, comprising:
providing, as inputs to a recurrent neural network (RNN), an ordered sequence of strings representing actions performed by a user within a software application, the RNN having been trained through a supervised learning process to:
generate embeddings of the ordered sequence of strings; and
generate a numerical score relating to a target action based on the embeddings and an order of the ordered sequence of strings;
receiving, as an output from the RNN in response to the inputs, the numerical score relating to the target action;
providing, as respective inputs to a tree-based classification machine learning model, the numerical score and an additional feature relating to the user;
receiving, as a respective output from the tree-based classification machine learning model in response to the respective inputs, a propensity score indicating a likelihood of the user to perform the target action; and
performing an action within the software application based on the propensity score.

2. The method of claim 1, further comprising:
retrieving activity history data for the user from one or more electronic data sources; and
extracting the ordered sequence of strings from the activity history data through a tokenization process.

3. The method of claim 1, further comprising computing, by the RNN, a sigmoid activation function based on the embeddings and the order of the ordered sequence of strings to generate the numerical score.

4. The method of claim 1, wherein the RNN comprises a long short term memory (LSTM) network trained based on historical ordered sequences of strings associated with labels indicating whether the target action was historically performed.

5. The method of claim 4, wherein the tree-based classification machine learning model comprises a gradient boosted tree model trained based on historical user features, including historical numerical scores output by the RNN, associated with the labels indicating whether the target action was historically performed.

6. The method of claim 1, further comprising receiving, from the tree-based classification machine learning model based on the respective inputs, explainability information indicating respective contributions of the numerical score and the additional feature to the propensity score.

7. The method of claim 1, further comprising receiving user feedback with respect to the propensity score, wherein the tree-based classification machine learning model is re-trained based on the user feedback.

8. The method of claim 1, further comprising receiving user feedback with respect to the propensity score, wherein the RNN is re-trained based on the user feedback.

9. The method of claim 1, wherein the performing of the action within the software application based on the propensity score comprises:
displaying content related to the target action within the software application based on the propensity score; or
generating a message related to the target action within the software application based on the propensity score.

10. A system for machine learning based action prediction, comprising:
one or more processors; and
a memory storing instructions that, when executed by the one or more processors, cause the system to:
provide, as inputs to a recurrent neural network (RNN), an ordered sequence of strings representing actions performed by a user within a software application, the RNN having been trained through a supervised learning process to:
generate embeddings of the ordered sequence of strings; and
generate a numerical score relating to a target action based on the embeddings and an order of the ordered sequence of strings;
receive, as an output from the RNN in response to the inputs, the numerical score relating to the target action;
provide, as respective inputs to a tree-based classification machine learning model, the numerical score and an additional feature relating to the user;
receive, as a respective output from the tree-based classification machine learning model in response to the respective inputs, a propensity score indicating a likelihood of the user to perform the target action; and
perform an action within the software application based on the propensity score.

11. The system of claim 10, wherein the instructions, when executed by the one or more processors, further cause the system to:
retrieve activity history data for the user from one or more electronic data sources; and
extract the ordered sequence of strings from the activity history data through a tokenization process.

12. The system of claim 10, wherein the instructions, when executed by the one or more processors, further cause the system to compute, by the RNN, a sigmoid activation function based on the embeddings and the order of the ordered sequence of strings to generate the numerical score.

13. The system of claim 10, wherein the RNN comprises a long short term memory (LSTM) network trained based on historical ordered sequences of strings associated with labels indicating whether the target action was historically performed.

14. The system of claim 13, wherein the tree-based classification machine learning model comprises a gradient boosted tree model trained based on historical user features, including historical numerical scores output by the RNN, associated with the labels indicating whether the target action was historically performed.

15. The system of claim 10, wherein the instructions, when executed by the one or more processors, further cause the system to receive, from the tree-based classification machine learning model based on the respective inputs, explainability information indicating respective contributions of the numerical score and the additional feature to the propensity score.

16. The system of claim 10, wherein the instructions, when executed by the one or more processors, further cause the system to receive user feedback with respect to the propensity score, wherein the tree-based classification machine learning model is re-trained based on the user feedback.

17. The system of claim 10, wherein the instructions, when executed by the one or more processors, further cause the system to receive user feedback with respect to the propensity score, wherein the RNN is re-trained based on the user feedback.

18. The system of claim 10, wherein the performing of the action within the software application based on the propensity score comprises:
displaying content related to the target action within the software application based on the propensity score; or
generating a message related to the target action within the software application based on the propensity score.

19. A non-transitory computer readable medium comprising instructions that, when executed by one or more processors of a computing system, cause the computing system to:
provide, as inputs to a recurrent neural network (RNN), an ordered sequence of strings representing actions performed by a user within a software application, the RNN having been trained through a supervised learning process to:
generate embeddings of the ordered sequence of strings; and
generate a numerical score relating to a target action based on the embeddings and an order of the ordered sequence of strings;
receive, as an output from the RNN in response to the inputs, the numerical score relating to the target action;
provide, as respective inputs to a tree-based classification machine learning model, the numerical score and an additional feature relating to the user;
receive, as a respective output from the tree-based classification machine learning model in response to the respective inputs, a propensity score indicating a likelihood of the user to perform the target action; and
perform an action within the software application based on the propensity score.

20. The non-transitory computer readable medium of claim 19, wherein the instructions, when executed by the one or more processors, further cause the computing system to:
retrieve activity history data for the user from one or more electronic data sources; and
extract the ordered sequence of strings from the activity history data through a tokenization process.
